(19) United States
(12) Patent Application Publication
(10) Pub. No.: US 2005/0127567 A1
(43) Pub. Date: Jun. 16, 2005

(54) Method of manufacturing woody formed body and woody formed body

(76) Inventor: Clive Eric DAvies, Waikanae (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/499,949

(22) PCT Filed: Jun. 5, 2003
(86) PCT No.: PCT/JP03/07171

(30) Foreign Application Priority Data
Jun. 7, 2002 (JP) 2002-167275

(51) Int. Cl. B29C 43/02

(52) U.S. Cl. 264/322

(57) ABSTRACT

A method of manufacturing a molded woody product 1 includes the steps of: softening a surface portion 2 of a primary molding body containing a woody material and a thermosetting binder; and compressing the primary molding body as a whole; and hardening the primary molding body as a whole in a state in which the primary molding body is compressed by the compressing step. In this manufacturing method, the primary molding body is compressed after softening the surface portion 2 thereof, thereby making it possible to selectively compress the surface portion 2. Then, by hardening the primary molding body as a whole in this state, it is possible to obtain a woody molded product whose surface portion 2 is of relatively high density and hardened, and whose inner portion 4 is of relatively low density.

### TECHNICAL FIELD

The present invention relates to a method of manufacturing a molded woody product produced by hot-press molding and to a molded woody product formed by hot-press molding.

### BACKGROUND ART

Molded products such as boards containing a woody material like wood chips as the main ingredient exhibit beneficial properties such as flexibility along with properties that inhibit the transfer or transmission of heat and sound. Conventionally, these products have been used in areas as heat insulating materials, sound insulating materials, etc. Further, molded woody products have come to be utilized as substitutes for molded resin products. Some molded woody products have been developed so as to exhibit strength equivalent to that of resin and yet be formed in with a relatively small thickness.

Generally speaking, the bending strength, heat and sound insulation capability, etc. of a plate-like molded woody member are satisfactory when the surfaces are hard while the inner portion is of a relatively lower density. To achieve this type of structure in a molded woody product, the surface portions are formed having a higher density as compared with the inner portion. Examples of a couple of conventional methods of forming such structures include one in which separately molded products differing in hardness are glued to each other, and one in which molding materials differing in specific gravity are stacked together and then collectively undergo press molding. In these methods, however, it is necessary to prepare a plurality of molding materials corresponding to the various specific gravities. The molding materials vary from one another according to the desired specific gravity of each portion and to the difference in specific gravity between the surface and inner portions. Further, in the case in which the molded products differing in specific gravity are glued together, a plurality of press-molded products are prepared, and then glued to one another, leading to a complicated process involving a large number of manufacturing steps and components.

### DISCLOSURE OF THE INVENTION

It is an object of the present invention to provide a relatively simple method of manufacturing a molded woody product exhibiting satisfactory bending strength and heat insulation ability. It is another object of the present invention to provide a molded woody product exhibiting satisfactory bending strength and heat insulation ability created using a relatively simple process.

To achieve the above objects, the present invention provides a molded woody product manufacturing method which includes the steps of: softening a surface portion of a primary molding body containing a woody material and a thermosetting binder; and compressing the primary molding body as a whole; and hardening the primary molding body as a whole in a state in which the primary molding body is compressed by the compressing step. In this manufacturing method, the primary molding body is compressed after softening the surface portion thereof, thereby making it possible to selectively compress the surface portion. Then, by hardening the primary molding body as a whole while in this state, it is possible to obtain a molded woody product whose surface portions, compressed to a larger degree than the inner volume, is of higher density and hardness than the inner portion, which is compressed to a smaller degree.

Further, to achieve the above objects, the present invention provides a molded woody product manufacturing method including the steps of: compressing a primary molding body as a whole while making the elasticity modulus in the compressing direction of the surface-side portion smaller than in the central portion of a primary molding body containing a woody material and a thermosetting binder; and hardening the primary molding body as a whole during a state in which the primary molding body is compressed by the compressing step. Here, the term “elasticity modulus in the compressing direction” refers to the compressive elasticity modulus, that is, the ratio of the compression stress to the compression distortion within the elasticity limit, for example, the compressive elasticity modulus as measured by the test method prescribed in JIS K 7208. In this manufacturing method, compression is effected, with the elasticity modulus in the compressing direction being smaller in the surface-side portion than in the central portion, thereby making it possible to selectively compress the surface-side portion of the primary molding body. By hardening the entire primary molding body while in this state, it is possible to obtain a molded woody product whose surface portion, compressed to a large degree, is of high density and hardness and whose inner portion, compressed to a smaller degree, is of relatively low density.

In this manufacturing method, when, in the compression step, the surface portion of the primary molding body contains more water than the inner portion thereof, the surface portion of the woody material is soft, and easier to compress. Thus, it is possible to make the degree of compression of the surface portion larger than that of the inner portion, thereby making it possible increase the density of the surface portion.

In the compressing state of this manufacturing method, it is possible to soften the surface portion of the primary molding body in a satisfactory manner by adding not less than 500 g/m² and not more than 3000 g/m² of water to the surface portion. Further, it is possible to prevent the temperature of the surface portion of the primary molding body from rising to the curing temperature during the compressing step, thereby preventing the surface portion from being cured during compression, subsequently reducing the degree of compression.

Further, when the water used also contains a basic ingredient, the texture of the woody material can be partially destroyed and made softer through hydrolysis or the like, thereby bringing the woody material into a condition in which it can be easily compressed.

Further, to achieve the above objects, the present invention provides a molded woody product manufacturing method including the steps of: softening a surface portion of a primary molding body containing a woody material and a thermosetting binder; compressing the primary molding body as a whole at a compression rate of 10 mm/s or more; and hardening the primary molding body as a whole in a state in which the primary molding body is compressed by the compressing step, in which a thickness portion of the resultant molded product corresponding to approximately 10% of the total thickness has an average density 200 kg/m³ or more, larger than that of a remaining portion. In the molded woody product obtained by this manufacturing method, the thickness portion exhibits a sufficient surface hardness and heat insulation ability. Thus, for example, the molded woody product can be utilized as a floor material or an inner wall material for a house, alone or in combination with a skin material or the like.

An example of the woody material that can be used in this manufacturing method includes particles obtained by crushing kenaf cores into pieces.

Further, the present invention produces a molded woody product which contains chipped woody materials and a thermosetting binder and whose surface portion to an approximate thickness corresponding to 10% of an entire thickness thereof has an average density larger than that of a remaining portion by approximately 200 kg/m³ or more. Further, the present invention produces a molded woody product in which the woody materials are in a form of particles obtained by crushing kenaf cores into pieces.

### BRIEF DESCRIPTION OF THE DRAWINGS

FIG. 1 is a perspective view of a molded woody product according to an embodiment of the present invention manufactured by a manufacturing method of the present invention.

FIG. 2 is a perspective view of a primary molding body used in an embodiment of the molded woody product manufacturing method of the present invention.

FIG. 3 is a plan view illustrating how the primary molding body is placed between press molds in an embodiment of the molded woody product manufacturing method of the present invention.

FIG. 4 is a plan view illustrating how the primary molding body is compressed in an embodiment of the molded woody product manufacturing method of the present invention.

FIG. 5 is a schematic diagram showing variations in density and in elasticity modulus in a compressing direction of surface and inner portions when the primary molding body is compressed in a vertical direction by a pair of press molds.

FIG. 6 shows density distribution of a molded woody product manufactured by a manufacturing method of the present invention.

FIG. 7 shows density distribution of a molded woody product manufactured by a manufacturing method of the present invention; and

### BEST MODE FOR CARRYING OUT THE INVENTION

An embodiment of the present invention will be described in detail with reference to the drawings.

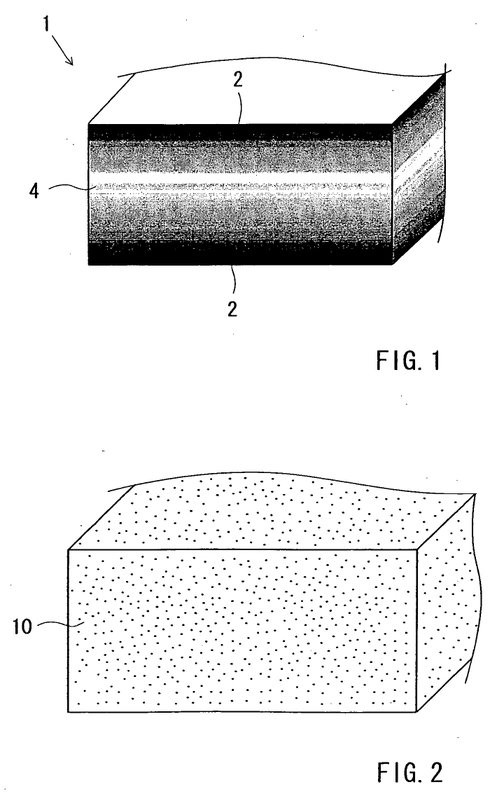

FIG. 1 shows a molded woody product 1 according to an embodiment of the present invention. The molded woody product 1 is formed of a material containing a woody material and a thermosetting resin for binding the woody material.

[Woody Material]

The woody material is a material containing fibers derived from arbors, shrubs, cane, bamboo, grass, or suitable plants, and is in the form of small pieces such as chips, flakes, fibers, powder, particles, or the like. The small pieces of woody material can be obtained for example through mechanical crushing, grinding, etc. of dried arbors or herbs. Further, it is also possible to use a woody material that has undergone various chemical treatments. For example, it is possible to use a fibrous material obtained through digestion, or a pulped material. There are no particular limitations regarding the size of the woody material. For example, in the case of the woody molded product 1 that is used as a building interior decoration material, it is desirable for the material to be in the form of an elongated body, chip, or particle, having an average length of approximately 1 to 10 mm.

[Thermosetting Resin]

The thermosetting resin is a resin that becomes permanently hard or rigid after curing, produced from a thermosetting resin material used as a well-known binder. Examples of such a resin include phenol resin, urea resin, melamine-urea resin, and isocyanate resin. The thermosetting resin is dispersed in the molded woody product 1, binding the woody materials together.

[Molded Woody Product]

It is possible for the molded woody product 1 to contain various sub-materials, such as preservatives, reinforcing materials, and coloring agents. Further, for example, as a reinforcing material the molded woody product 1 may contain a fibrous material, such as carbon fiber, glass wool, or thermoplastic synthetic fiber.

The entire molded woody product 1 is formed of the same material. A surface portion 2 is on either side (top and bottom as shown in FIG. 1) formed so as to be of high density and hardness, with the density greatly diminishing towards the inner portion. The inner portion 4 is of a lower density than the surface portions 2 and is substantially uniform.

The surface portions 2, in which a thermosetting resin closely binds the woody material chips to each other, are of relatively high density. Most of the woody material chips in the surface portions 2 are compressed to become hard, losing the flexibility normally inherent in the woody material. Further, it is possible for the woody material chips or woody material fibers to be glued together by a decomposition ingredient generated by hydrolysis, such as lignin or hemicellulose. In this case, the woody material is formed into a relatively harder structure. The entire surface portions 2, including the woody material, are hardened and exhibit high strength.

In contrast, the woody material of the inner portion 4 is compressed to a smaller degree than that of the surface portions 2, and therefore exhibits lower density. The woody material chips have undergone little or substantially no deformation by compression and held in contact with each other via small contact areas, resulting in a loose, or more flexible state. The resulting inner portion 4 comprises a structure with a large number of gaps.

The molded woody product 1 has the surface portions 2 formed with high density to obtain a hardened structure while the inner portion 4 is formed at low density, thereby achieving an improvement in heat and sound insulation ability. Further, due to the sandwich type of structure, characterized by the surface portions 2 being of high density and the inner portion 4 being of low density, the molded woody product 1 as a whole exhibits high bending rigidity and compression strength. In particular, as compared with a molded woody product having the same thickness and uniform density, the molded woody product 1 exhibits higher bending rigidity and strength. As compared with a molded woody product having the same thickness, same surface hardness, and uniform density, the molded woody product 1 is lighter.

Thus, this molded woody product 1 can be utilized as a member where a predetermined level of bending rigidity and compression strength are required, and as a member of which a predetermined level of heat insulation ability and/or sound insulation ability are required. For example, the molded woody product 1 can be suitably utilized in construction as a floor material, or an inner wall material. Furthermore, due to the high level of surface hardness, the molded woody product 1 can be utilized as a floor material or an inner wall material without requiring an additional member for surface protection, such as a skin material. In particular, a molded woody product 1 whose surface portions 2 have a thickness approximating 10% of the entire thickness of the molded woody product 1, in which the difference in density between the surface portions 2 and the inner portion 4 is 200 kg/m³ or more, which exhibits high bending rigidity and compression strength, and which has satisfactory heat and sound insulation ability, can be suitably utilized alone as a floor material or an inner wall material.

[Molded Woody Product Manufacturing Method]

A molded woody product manufacturing method of the present invention as applied to the production of the molded woody product 1 of FIG. 1 will be described in detail with reference to FIGS. 2 through 5.

In the molded woody product manufacturing method according to the present invention, a molding material containing a woody material and a thermosetting binder is prepared. The woody material contained in the molding material is as described above. The thermosetting binder is a resin turned into the above thermosetting resin through curing. Preferably a thermosetting binder is selected having a curing temperature higher than the temperature at which the woody material is softened by heating (and vapor). For this reason, the woody material can be softened by being heated to a temperature that does not cause the curing of the thermosetting binder. For example, when the woody material consists of chips (particles) obtained by finely cutting the core material of a kenaf (kenaf core), phenol resin can be suitably used.

While there are no particular limitations regarding the relative proportion of the thermosetting binder to the woody material, it is desirable for the thermosetting binder to be not less than 5 parts by weight and not more than 25 parts by weight, to 100 parts by weight of the woody material, when a molded woody product is to be manufactured for use as a building interior decoration material. Further, when it is desired to impart to the molded woody product a hardness level high enough to allow its surface portion 2 to function as a contact surface, touched by humans, for example a surface such as a floor surface, it is preferable for the thermosetting binder to be not less than 10 parts by weight and not more than 20 parts by weight, to 100 parts by weight of the woody material. For example, when a primary molding body 10 consists of a woody material in the form of chips derived from kenaf cores having an average length of 5 mm and a phenol resin material in the form of powder, it is desirable for their weight ratio to be approximately 9:1.

The woody material and the thermosetting binder are supplied in a condition in which they are uniformly mixed with each other. Typically, the thermosetting binder is in the form of a powder and is mixed into the woody material finely cut into a predetermined configuration. The materials undergo agitation or the like until they are brought into a substantially uniform consistency. Further, it is possible to use a well-known method that allows the thermosetting binder to be uniformly dispersed throughout the woody material, for example, by causing the binder to adhere to the woody material surface by utilizing static electricity.

In the manufacturing method of the present invention, the molding material is formed into the primary molding body 10 of a predetermined configuration. The molding material is shaped into the predetermined configuration with a uniform thickness and uniform density by using a well-known forming device. The primary molding body 10 of this embodiment, shown in FIG. 2, has a thickness larger than that of the finished molded woody product 1. And primary molding body 10 is in a configuration substantially similar to that of the molded woody product 1.

The manufacturing method of the present invention includes a step in which the surface portions 2 of the primary molding body 10 are softened before the compressing of the entire primary molding body 10.

The softening of the surface portions 2 of the primary molding body 10 can be accomplished by various methods. Typically, through a combination of heating and the addition of water, it is possible to efficiently soften the woody material. It is desirable for the temperature during this process to be lower than the curing temperature of the thermosetting binder. The woody material is expanded and moistened by water, and is therefore easily softened.

While there are no particular limitations regarding the amount of water added, if the amount of added water is too small, the woody material may not be softened to a sufficient degree, or only the superficial surfaces are softened, with the portions extending just below the surface remaining in their unsoftened state. This could result in concern about creating sufficient increases in the surface hardness. On the other hand, if the amount of water added is too large, there is an increase in the requisite quantity of heat required to heat the primary molding body 10 to the curing temperature of the thermosetting binder, resulting in a relatively long molding times. Preferably, the amount of water added is not less than 500 g/m² and not more than 3000 g/m² with respect to the surfaces of the primary molding body 10.

Further, it is desirable for the water to be an aqueous solution containing a basic ingredient. Examples of an aqueous solution containing a basic ingredient include aqueous solutions of sodium hydroxide, ammonia, and potassium hydroxide. Use of an aqueous solution containing a basic ingredient makes the hemicellulose, lignin, etc. in the woody material more soluble, making it possible to readily soften the woody material. Also in the situation in which an aqueous solution containing a basic ingredient is used, it is desirable for the amount of water to be not less than 500 g/m² and not more than 3000 g/m² with respect to the surfaces of the primary molding body 10.

Further, by using layers of woody material with a large water content solely in the surface portions on either side of a lower water content woody material inner portion, it is possible, without adding any water, to attain a condition in which the water content is larger in the surface portions than in the inner portion. Using this method, it is possible to soften the woody material solely by heating.

There are no particular limitations regarding the way water is added. For example, it is possible to immerse the surface portions 2 of the primary molding body 10 in a water vessel or the like, or to spray water by a sprayer or atomizer. Spraying of water by a sprayer is preferable since it is possible to add an appropriate amount of water solely to the surface portions 2 of the molding material.

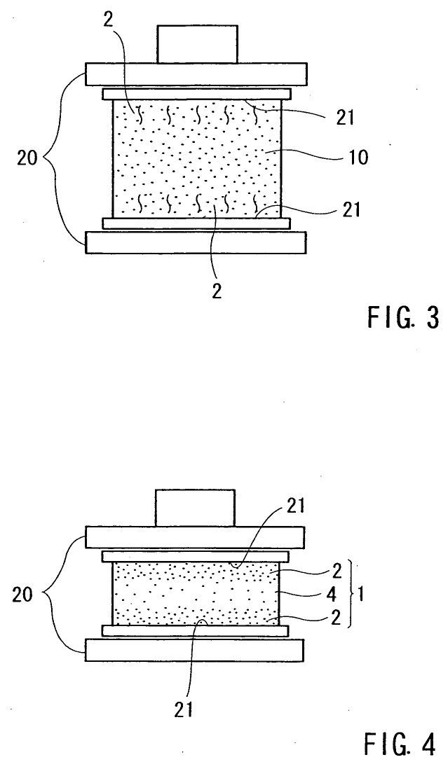

The compression of the primary molding body 10 can be performed by a well-known press molding device. FIG. 3 is a plan view showing the primary molding body 10 placed between press molds 20 in an embodiment of a manufacturing method for the molded woody product 1 of the present invention. FIG. 4 is a plan view showing the primary molding body 10 of FIG. 3 compressed to produce the molded woody product 1. In this particular embodiment for example, a pair of press molds 20 are used whose upper and lower press surfaces 21 are flat. Each of the press surfaces 21 can be heated to a desired temperature, making it possible to heat the material at some point during the compression. There are no particular limitations regarding the press molds 20. For example, servo control type press molds, in which the compression rate, etc. can be easily controlled, are suitably used.

The compression is continued until the primary molding body 10 is reduced to approximate the thickness of the molded woody product 1. The compression of the primary molding body 10 may be performed either after the softening of the surface portions 2, or simultaneously with the softening of the surface portions 2. The compression is accomplished while the primary molding body 10 is in the state in which the surface portions 2 are softened and inner portion 4 is harder than the surface portions 2. Thus, it is desirable for the compression of the primary molding body 10 to be concluded quickly in a short period of time after the softening of the surface portions 2 since that will cause heat to be transmitted to the inner woody material portion with the passage of time, making it possible to selectively compress the surface portions prior to the softening. In particular, in the case in which heating is effected from the surface sides of the primary molding body 10, by continuing the heating with the compression, it is possible to more quickly pressurize the surface side portions that are softened earlier, making it possible to efficiently increase the surface compression ratio.

Further, it is also possible to preheat the heating medium, for example the press surfaces 21, to a temperature higher than the curing temperature of the thermosetting binder, and to soften the woody material with this heating medium, utilizing the initial heating stage where the temperatures of the surface portions 2 of the primary molding body 10 are lower than the curing temperature. In this method, it is desirable to perform the compression along with the heating, and more preferably, to complete the compression before the surfaces start to be cured. For example, when water is added to the surface portions 2 of the primary molding body 10 with a thickness of 70 mm, in order to form it into a molded woody product 1 with a thickness of 10 mm, it is desirable for the compression rate to be at least 10 mm/s. It is desirable for the primary molding body 10 to be compressed to a predetermined thickness within five seconds after coming into contact with the press surfaces 21.

In this embodiment, a primary molding body 10 to which water has been previously added was placed between the press molds 20. Then, as shown in FIG. 3, the press surfaces 21, previously heated to a temperature at least as high as the curing temperature of the thermosetting binder, were brought into contact with the surfaces of the primary molding body 10 for initial heating of the surface portions 2. Then, the press molds 20 were moved toward each other until a predetermined thickness was attained, thus compressing the primary molding body 10.

As shown in FIG. 4, as a result of this compression, the softened surface portions 2 of the primary molding body 10, are easily deformed by the compression pressure and compressed to attain a relatively high density. In contrast, the inner portion 4 exhibits a higher elasticity modulus than the surface portions 2, and the pressure applied to the inner portion 4 is lower than the surface portions 2 in part because of the absorption of the compressive force due to the greater deformation of the surface portions 2. The result is that the woody molding material of the inner portion 4 is relatively little deformed. Thus, even after the completion of the compression, the inner portion 4 still exhibits a large number of clearances and is of lower density.

Next, the entire primary molding body 10 is hardened in the compressed state after the completion of the compression process. The hardening is accomplished by heating the primary molding body 10. There are no particular limitations regarding the manner of heating. Typically, the heating is performed by the press surfaces 21 of the press molds 20. The press surfaces 21 of the press molds 20 have been brought into pressing contact with the surfaces of the primary molding body 10 during the above-described compression process. By maintaining this state (shown in FIG. 4) for a predetermined period of time, it is possible to conduct heat from the press surfaces 21 to the surface portions 2 of the press molding body 10, and then into the inner portion 4. By heating the primary molding body 10 to the curing temperature for the thermosetting binder, the primary molding body 10 is hardened with the density gradient established in the compression process, whereby molded woody product 1 is obtained.

In this manufacturing method, by causing the surface portions 2 to be softer than the inner portion 4 during the step of compressing the primary molding body 10, it is possible to attain a higher density in the surface portions 2 and a relatively lower density in the inner portion 4 with one compression stroke. Then, by curing the thermosetting binder while maintaining this state, it is possible to obtain a molded woody product 1 whose surface portions 2 are hardened and while the inner portion 4 has a relatively lower density with gaps and clearances. Using this method, it is possible to produce a molded woody product 1 whose surface portions 2 and inner portion 4 are compressed to different extents with one compression and heat curing process, thereby achieving a reduction in the number of manufacturing steps and an overall improvement in efficiency.

Further, in the manufacturing method of this embodiment, by adjusting the manner of softening and the compression rate, it is possible to adjust the hardness (density) and thickness of the surface portions, more specifically, the difference in density between the surface and inner portions and the relative thickness proportions therebetween. Thus, for example, it is possible to obtain a molded woody product exhibiting a difference in specific gravity along the thickness direction with a single material and process. Further, it is also possible to obtain a molded woody product exhibiting a greater difference in density between the surface and inner portions by using different materials.

[Regarding Compressive Elasticity Modulus]

Further, in this embodiment, during the step of compressing the primary molding body 10, if the elasticity modulus in the compressing direction is made lower in the surface portions than in the central portion of the primary molding body 10, it is possible to attain a higher density in the surface portions 2 and a relatively low density in the inner portion 4 with one compression stroke. Then, by curing the thermosetting binder while maintaining this state, it is possible to obtain a molded woody product 1 whose surface portions 2 are hardened and whose inner portion 4 is of relatively low density and contains clearances.

As stated above, in order to adjust the compressive elasticity modulus in the primary molding body 10, it is possible to take measures such as addition of water or heating. For example, by heating the surface portions 2 of the primary molding body 10 using the press surfaces 21, it is possible to make the compressive elasticity modulus of the surface portions 2 relatively lower than that of the inner portion 4. Further for example, by adding water to the surface portions 2 via a sprayer or the like, it is also possible to make the compressive elasticity modulus of the surface portions 2 lower than that of the inner portion 4. When adjusting the compressive elasticity modulus by adding water, it is desirable that the amount of water added to the surfaces of the primary molding body 10 be not less than 500 g/m² and not more than 3000 g/m². When the amount of added water is below this range, the woody material contained within the primary molding body 10 is not softened to a sufficient degree. When the amount of added water is above this range, there is an increase in the requisite quantity of heat needed to allow the primary molding body 10 attain the curing temperature of the thermosetting binder, resulting in an increased molding time. Additionally, in order to easily cause the softening of the woody material contained in the primary molding body 10, it is desirable for the added water to contain a basic ingredient.

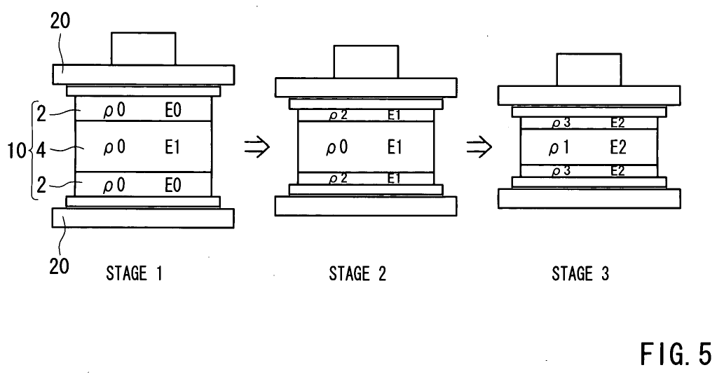

FIG. 5 is a schematic diagram showing the changes in the density and the elasticity modulus along the compressing direction (the vertical direction shown in FIG. 5) in the surface portions 2 and the inner portion 4 when the pair of press molds 20 compresses the primary molding body 10.

As shown in FIG. 5, during the first stage no pressure is applied to the primary molding body 10. The density of the surface portions 2 is ρ0[g/m³], and the density of the inner portion 4, located between the surface portions 2, is also ρ0[g/m³]. The elasticity modulus in the compressing direction (vertical direction) of the surface portions 2 is E0[N/m²], and the elasticity modulus in the compressing direction of the inner portion 4 is E1[N/m²]. In this first stage, E1 is greater than E0, so that when a compressive force is applied to the primary molding body 10 by the pair of press molds 20, the surface portions 2 are compressed to a large degree prior to the compression of the inner portion 4.

As shown in FIG. 5, in the second stage pressure is applied to the primary molding body 10 by the pair of press molds 20. The density of the surface portions 2 changes to ρ2[g/m³], and the density of the inner portion 4 is ρ0[g/m³]. The elasticity modulus in the compressing direction of the surface portions 2 changes to E1[N/m²], and the elasticity modulus in the compressing direction of the inner portion 4 remains E1[N/m²]. From the first to the second stage, the density of the surface portions 2 increases from ρ0 to ρ2, and the elasticity modulus in the compressing direction of the surface portions 2 increases to E1. At this point, the elasticity modulus in the compressing direction of the surface portions 2 is substantially equal to the elasticity modulus in the compressing direction of the inner portion 4.

As shown in FIG. 5, in the third stage compression of the primary molding body 10 by the pair of press molds 20 is completed to obtain the molded woody product 1. The density of the surface portions 2 changes to ρ3[g/m³], and the density of the inner portion 4 changes to ρ1[g/m³]. The elasticity modulus in the compressing direction of the surface portions 2 changes to E2[N/m²], and the elasticity modulus in the compressing direction of the inner portion 4 also changes to E2[N/m²]. From the second to the third stage, the density of the surface portions 2 increases from ρ2 to ρ3, and the elasticity modulus in the compressing direction of the surface portions 2 increases from E1 to E2. Further, the density of the inner portion 4 also increases from ρ0 to ρ1, and the elasticity modulus in the compressing direction of the inner portion 4 also increases from E1 to E2, which is substantially equal to the elasticity modulus in the compressing direction of the surface portions 2. In the first through the third stages, ρ0 is less than ρ2, and ρ1 is less than ρ3. When fully compressed, the primary molding body 10 is heated by the press surfaces of the pair of press molds 20, the binder consisting of a thermosetting resin is cured, and a molded woody product 1 is obtained in which the density distribution of the third stage is substantially maintained throughout the thickness.

As described above, by applying compressive force to the primary molding body 10 by the pair of press molds 20 during the first through third stages, it is possible to obtain a molded woody product 1 whose surface portions 2 are relatively hard due to the structure of the woody material at a high density while the inner portion 4 is relatively soft due to the structure of the woody material at a low density. As described above, to obtain the molded woody product 1 by the above series of steps, it is required that the elasticity modulus in the compressing direction be lower in the surface-side portions than in the central portion. In the first through third stages, by making the pressing rate of the pair of press molds 20 as high as practical, it is possible to more selectively compress the surface portions 2. Accordingly, it is possible to even more efficiently manufacture a molded woody product 1 whose surface portions 2 are harder than the inner portion 4 thereof.

### EXAMPLES

### Example 1

To prepare a woody material, Kenaf cores were crushed into chips with a length of approximately 5 mm. The woody material was mixed with 10 wt % of phenol resin to prepare a molding material and formed into a mat with a thickness of 70 mm. Next, both sides of the primary molding body thus formed were sprayed with water in an amount approximately equal to 2000 g/m². Press surfaces heated to 180° C. were brought into contact with both surfaces in order to apply compression at the compression rate of 10 mm/s, with the target density being 0.5 g/cm³. Heating was provided in the compressed state for approximately 10 minutes to cure the entire primary molding body. The resultant molded woody product has a thickness of approximately 10 mm.

As a comparative example, a similar primary molding body was prepared and formed into a molded woody product with a thickness of 10 mm under the same conditions with the exception that the compression rate was 1 mm/s instead of 10 m/s.

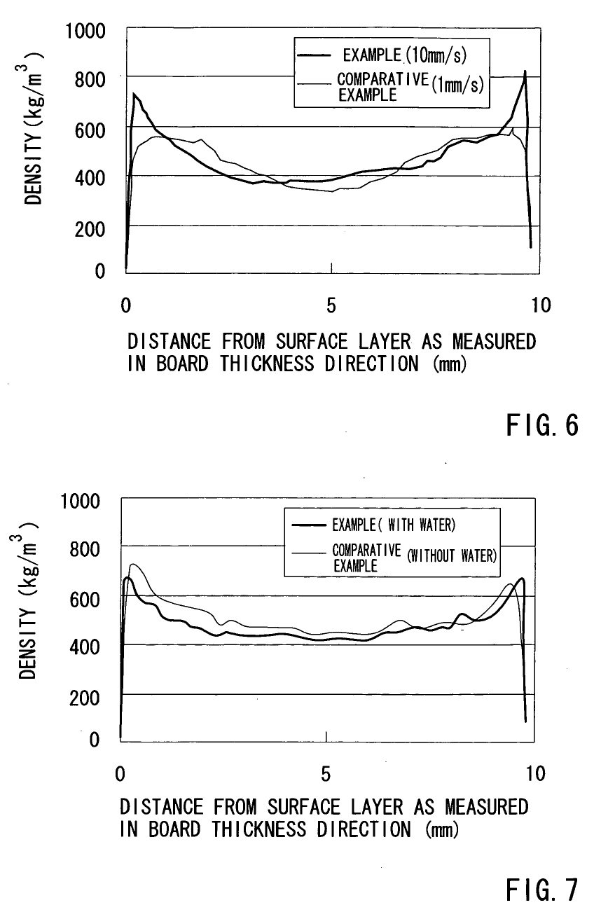

Density distribution measurements were performed on the two molded woody products obtained using the color distribution of an X-ray of each of the molded woody products. FIG. 6 shows the resultant density distributions.

As shown in FIG. 6, the density of Example 1 (molded at 10 mm/s) was extremely high to a depth of approximately 1 mm below the surfaces of the molded product, thus indicating that the surfaces were hardened. In contrast, in the density of the inner portion was fairly consistent and lower than the surface portions. Thus establishing that the inner portion of Example 1 has a lower density than the surface portions and a relatively uniform density distribution. Further, it became apparent that the average density of the portions extending to a depth of 1 mm from each of the surfaces (corresponding to approximately 10% of the entire thickness) is larger than the average density of the remaining portion by about 200 kg/m³ or more. In the comparative example, although the inner portion is in a similar low-density state as in Example 1, no similar large changes in density was observed near the surfaces. However, it became apparent that there does exist, in the portions to a thickness of approximately 2 mm from the surfaces, regions exhibiting a substantially fixed density that is higher than the density of the inner portion. When compared with the density of the surface portions of the Example 1, the density of these comparative regions was lower by an amount approximately equal to 150 to 200 kg/m³. From this, it is predicted that the curing of the surface portions starts during compression in the comparative example. This would cause the compression to be more evenly dispersed through out the thickness of the molded product, making the density of the surface portions, and correspondingly, the hardness of the surface portions, lower than that of Example 1.

### Example 2

The woody material of a primary molding body was prepared by crushing Kenaf cores into chip-like pieces with a length of approximately 5 mm. The surface side portions of the primary molding body were obtained by impregnating this woody material with 50% by weight of water. The proportions between the first surface portion, the inner portion, and the second surface portion, were 2:6:2, with the weight in the dried state taken as the reference. The woody material was mixed with 10 wt % of phenol resin with and formed into a mat shape with a thickness of 70 mm. Press surfaces heated to 180° C. were brought into contact with the surfaces of the mat-shaped primary molding body. Compression was performed at a compression rate of approximately 5 mm/s, with the target density being 0.5 g/cm³. Heating was applied in the compressed state for approximately 10 minutes in order to cure the entire primary molding body. The resulting molded woody product obtained had a size of 300 mm×300 mm and a thickness of 10 mm.

A comparative example was formed under the same conditions, except that the woody material forming the surface portions contained no added water. Press surfaces were brought into contact with the primary molding body of the comparative example to compress the comparative example under the same conditions as in Example 2, thereby obtaining a molded woody product having a size of 300 mm×300 mm and a thickness of 10 mm.

Density distribution measurements were performed on the molded woody products thus obtained based upon the color distribution in X-ray's of each of the molded woody products. FIG. 7 shows the resultant density distribution.

As shown in FIG. 7, the density was high in Example 2 in the portions to a depth of 1 mm from each of the surfaces of the molded product, thus indicating that the surfaces had been hardened. In contrast, the density of the inner portions is relatively small with little variation, thereby establishing that the inner portion had a lower density than the surface portions and a relatively uniform density distribution. In comparative example, although the inner portion is in a low-density state similar to Example 2, no sharp increases in density near the surfaces as shown in the Example 2 were observed in the portions of the comparative example to a depth of approximately 1 mm from the surfaces.

As described above, according to the present invention, there is provided a method in which it is possible to produce a molded woody product superior in bending strength and heat insulation ability through a relatively simple process. This method allows for the possibility to manufacture less expensive heat insulator materials, house interior decoration materials, etc. by using woody materials.

Further, by providing a molded woody product superior in bending strength and heat insulation capability, it is possible to utilize such a molded woody product where the requirements call for a member to be superior in heat insulation ability and surface strength, such as in a flooring material.

A representative example of the present invention has been described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the foregoing detailed description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present teachings.

1-9. (canceled)

10. A method of manufacturing a molded woody product comprising the steps of:
softening a surface portion of a primary molding body containing a woody material and a thermosetting binder; and
compressing the primary molding body as a whole; and
hardening the primary molding body as a whole; and
hardening the primary molding body as a whole in a state in which the primary molding body is compressed by the compressing step.

11. A method of manufacturing a molded woody product according to claim 10, wherein, in the compressing step, the surface portion of the primary molding body contains more water than an inner portion thereof.

12. A method of manufacturing a molded woody product according to claim 11, wherein, in the compressing step, not less than 500 g/m² and not more than 300 g/m² of water is added to the surface portion of the primary molding body.

13. A method of manufacturing a molded woody product according to claim 12, wherein the water contains a basic ingredient.

14. A method of manufacturing a molded woody product according to claim 13, wherein the woody material is in a form of particles obtained by crushing kenaf cores into pieces.

15. A method of manufacturing a molded woody product comprising the steps of:
compressing a primary molding body as a whole while making an elasticity modulus in a compressing direction similar in at least one surface portion of the primary molding body containing a woody material and a thermosetting binder than in a central portion thereof; and
hardening the primary molding body as a whole in a state in which the primary molding body is compressed by the compressing step.

16. A method of manufacturing a molded woody product according to claim 15, wherein, in the compressing step, the surface portion of the primary molding body contains more water than an inner portion thereof.

17. A method of manufacturing a molded woody product according to claim 16, wherein, in the compressing step, not less than 500 g/m² and not more than 3000 g/m² of water is added to the surface portion of the primary molding body.

18. A method of manufacturing a molded woody product according to claim 17, wherein the water contains a basic ingredient.

19. A method of manufacturing a molded woody product according to claim 18, wherein the woody material is in a form of particles obtained by crushing kenaf cores into pieces.

20. A method of manufacturing a molded woody product comprising the steps of:
softening a surface portion of a primary molding body containing a woody material and a thermosetting binder; and
compressing the primary molding body as a whole at a compression rate of 10 mm/s or more; and
hardening the primary molding body as a whole in a state in which the primary molding body is compressed by the compressing step,
wherein a thickness portion of the molded product thus obtained to a thickness corresponding to 10% of an entire thickness has an average density larger than that of a remaining portion by 200 kg/m³ or more.

21. A method of manufacturing a molded woody product according to claim 20, wherein the woody material is in a form of particles obtained by crushing kenaf cores into pieces.

22. A molded woody product comprising woody material chips and a thermosetting binder,
wherein a thickness portion of the molded woody product to a thickness corresponding to 10% of the entire thickness thereof has an average density larger than that of a remaining portion by 200 kg/m³ or more.

23. A molded woody product according to claim 22, wherein the woody material chips are in a form of particles obtained by crushing kenaf cores into pieces.
